(19) United States
(12) Patent Application Publication
(10) Pub. No.: US 2011/0058392 A1
(43) Pub. Date: Mar. 10, 2011

(54) CURRENT-SHARING POWER SUPPLY APPARATUS

(76) Inventors: Shih-Chang Lee, Taipei Hsien (TW); Chung-Shu Lee, Taipei Hsien (TW)

(21) Appl. No.: 12/554,856

(22) Filed: Sep. 4, 2009

(51) Int. Cl. H02M 3/335

(52) U.S. Cl. 363/16

(57) ABSTRACT

A current-sharing power supply apparatus includes a conversion circuit, a square-wave generating circuit, a resonant circuit, a rectifier circuit, and a filter circuit. The conversion circuit has two transformers, and each of the transformers has a primary winding and at least one secondary winding. More particularly, two secondary windings of the two transformers are electrically connected in series. The square-wave generating circuit is electrically connected to a DC voltage to switch the DC voltage into a pulsating voltage. The resonant circuit is electrically connected to the square-wave generating circuit, and having a first capacitor and the primary windings of the transformers. The rectifier circuit has at least two switch components, and electrically connected to the secondary windings of the transformers to rectify an AC output voltage into a rectified voltage, and the rectified voltage is outputted to at least one voltage output terminal.

### BACKGROUND OF THE INVENTION

1. Field of the Invention

The present invention relates to a power supply apparatus, and more particularly to a current-sharing power supply apparatus.

2. Description of Prior Art

In electronic engineering, a DC-to-DC converter is an electronic circuit which converts a source of direct current (DC) from one voltage level to another, and the converted DC voltage is stabilized at the preset voltage value. Generally speaking, the DC-to-DC converter is divided into two categories: one is “step-down” DC-to-DC converter (namely, the output voltage is lower than the input voltage), and the other one is “step-up” DC-to-DC converter (namely, the output voltage is higher than the input voltage). The DC-to-DC converter is mainly applied to a distributed power system. Hence, the DC voltage level of the previous stage is fixed, and the DC voltage level of the next stage can be connected to the corresponding DC-to-DC converter according to the required power.

More particularly, the DC-to-DC converter can be separated into two categories: the pulse width modulation (PWM) converter and the resonant converter. The hard-switching operation of the PWM converter introduces the high switching losses and the poor efficiency. Accordingly, the soft-switching technologies have been developed for the resonant converter to reduce the switching losses and increase the efficiency.

The DC characteristic of the LLC resonant converter could be divided into ZVS (zero-voltage switching) region and ZCS (zero-current switching) region. A resonant ZCS/ZVS switch (Zero Current/Zero Voltage) where each switch cycle delivers a quantized packet of energy to the converter output, and switch turned-on and turned-off occurs at zero current and voltage, resulting in an essentially lossless switch. Accordingly, the LLC resonant circuit structure is adopted in high-efficiency and high-power power circuits.

Reference is made to FIG. 1 which is a circuit diagram of a prior art LLC resonant circuit. The LLC resonant circuit includes a DC voltage 100, a square-wave generating circuit 102, a resonant circuit 104, a conversion circuit 106, a rectifier circuit 108, and a filter circuit 110.

The square-wave generating circuit 102 is composed of two semiconductor components Q_{T}, Q_{B}, and on-state and off-state of the two semiconductor components Q_{T}, Q_{B} are controlled by a controller 120. Hence, the square-wave generating circuit 102 can generate two different voltage levels. The resonant circuit 104 is composed of a resonant capacitor Cr and primary windings n₁ of two transformers Ta, Tb. The resonant capacitor Cr is provided to filter a DC component of a pulsating voltage generated by the square-wave generating circuit 102 and an AC component of the pulsating voltage is resonated. Also, each of the primary windings n₁ of the transformers Ta, Tb is provided to transform electrical energy into magnetic energy, and the transformed magnetic energy is delivered to corresponding secondary windings of the transformers Ta, Tb.

The rectifier circuit 108 is composed of four rectifier diodes D1, D2, D3, D4. The function of rectifying and filtering is implemented based on the single-directional turned-on property of the diodes D1, D2, D3, D4 and the charging and discharging property of the filter capacitor Co. The description of operating the LLC resonant converter is as follows. The filter circuit 110 includes a filter capacitor Cout to reduce a voltage ripple of the DC output voltage to smooth the variation of the DC output voltage based on the charging and discharging property of the filter capacitor Cout.

The detailed operation is explained as follows. First, a pulsating voltage is generated at a node A when the DC voltage 100 is provided to the square-wave generating circuit 102. Afterward, the resonant capacitor Cr filters the DC component of the pulsating voltage and the AC component of the pulsating voltage is resonated when the pulsating voltage passes through the resonant circuit 104. Afterward, the resonated AC voltage and resonated AC current are outputted at the conversion circuit 106, namely the secondary windings n₂ of the transformers Ta, Tb. Finally, the AC voltage is rectified by the rectifier circuit 108 and is filtered a filter circuit 110 to generate a DC voltage which is outputted to a voltage output terminal Vout.

The self inductance (including the leakage inductance and the magnetizing inductance) of the transformer is the main energy-storage component of the resonant circuit. Hence, it is careful to handle the winding connection for multiple transformers are used when the high-power circuit in-series or in-parallel resonant circuits are used when the high-power circuit is applied. In addition, the amount of the rectifier diodes and the turns of the secondary windings are large, thus increasing the losses and reduce the efficiency.

### SUMMARY OF THE INVENTION

The purpose of the present invention is to provide a current-sharing power supply apparatus, and the power supply apparatus is applied to a high-power circuit.

In order to achieve the object mentioned above, the current-sharing power supply apparatus includes a square-wave generating circuit, a resonant circuit, a conversion circuit, a rectifier circuit, and a filter circuit.

The conversion circuit has two transformers, and each of the transformers has a primary winding and at least one secondary winding. More particularly, the secondary windings of the different transformers are electrically connected in series.

The square-wave generating circuit is electrically connected to a DC voltage to switch the DC voltage into a pulsating voltage. The resonant circuit is electrically connected to the square-wave generating circuit, and the resonant circuit has a first capacitor and the primary windings of the transformers. More particularly, the first capacitor is a resonant capacitor.

The rectifier circuit has at least two switch components. Also, the rectifier circuit is electrically connected to the secondary windings of the transformers to rectify an AC voltage outputted from the secondary windings into a rectified voltage, and the rectified voltage is outputted to at least one voltage output terminal. More particularly, the switch components are rectifier diodes.

In addition, the rectifier diodes can be replaced by the MOSFETs to compose a synchronous rectify circuit. More particularly, the synchronous rectify circuit further has one diode electrically connected between a drain and a source of each MOSFET.

The current-sharing power supply apparatus further includes a filter circuit. The filter circuit has at least one second capacitor, which is a filter capacitor. The filter circuit is provided to reduce a voltage ripple of the DC output voltage to smooth the variation of the DC output voltage based on the charging and discharging property of the second capacitor.

Accordingly, the secondary windings of two transformers are electrically connected in series to balance the magnetic flux of the two transformers to provide a current-sharing function. In addition, the amount of the diodes and the turns of the secondary windings is less to reduce the losses and increase the efficiency.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a prior art LLC resonant circuit;

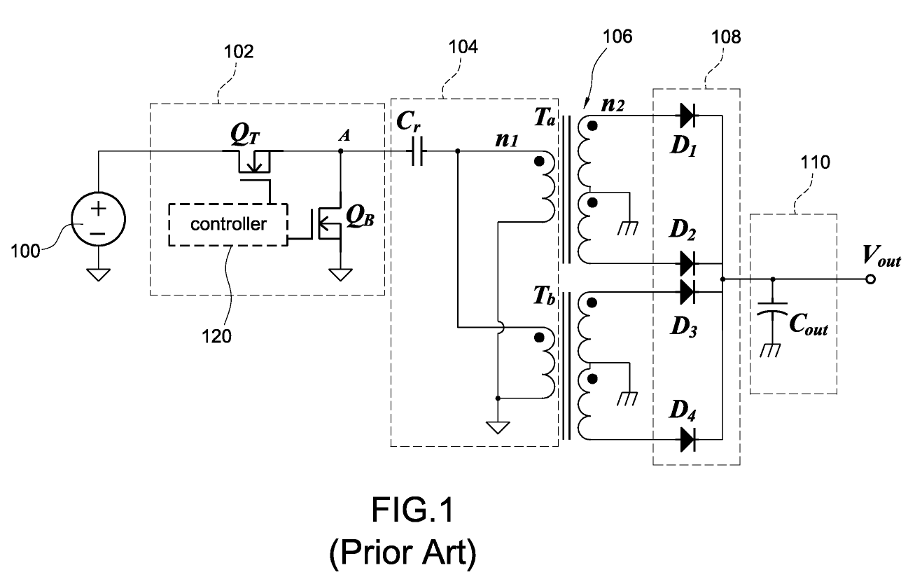

FIG. 2 is a circuit diagram of a first embodiment of a power supply apparatus according to the present invention;

FIG. 3 is a circuit diagram of a second embodiment of the power supply apparatus;

FIG. 4 is a circuit diagram of a third embodiment of the power supply apparatus;

FIG. 5 is a circuit diagram of a fourth embodiment of the power supply apparatus;

FIG. 6 is a circuit diagram of a fifth embodiment of the power supply apparatus; and

FIG. 7 is a circuit diagram of a sixth embodiment of the power supply apparatus.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

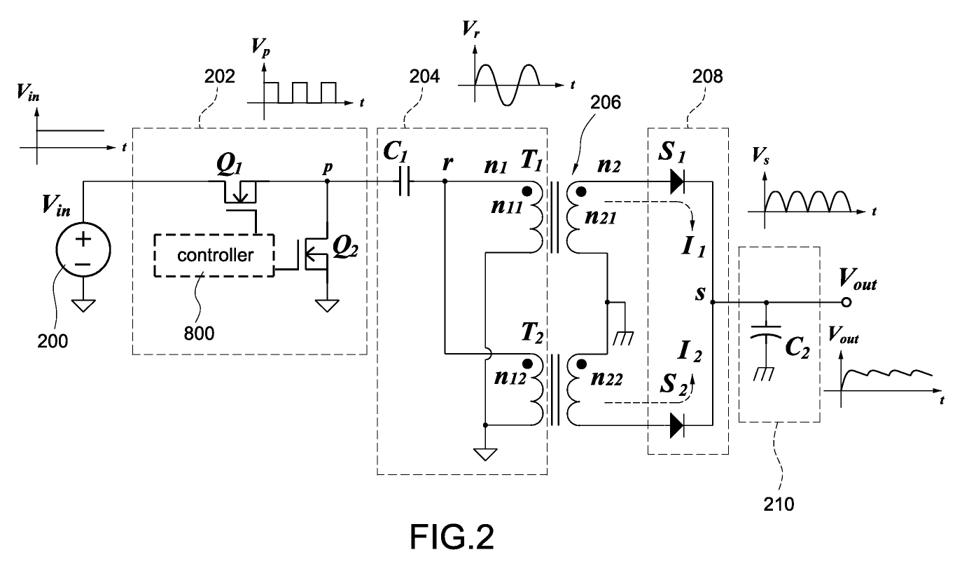

Reference will now be made to the drawing figures to describe the present invention in detail. Reference is made to FIG. 2 which is a circuit diagram of a first embodiment of a power supply apparatus according to the present invention. The power supply apparatus is a DC-to-DC converter to convert a DC voltage 200 at a voltage input terminal Vin from one voltage level to another voltage level required for a back-end circuit. The power supply apparatus includes a square-wave generating circuit 202, a resonant circuit 204, a conversion circuit 206, and a rectifier circuit 208.

The conversion circuit 206 has two transformers T1, T2, and each of the transformers Ta1, T2 has a primary winding n₁ and a secondary winding n₂. More particularly, the left-side winding of the conversion circuit 206 is the primary winding n₁, and the right-side winding of the conversion circuit 206 is the secondary winding n₂. The first transformer T1 has a first primary winding n₁₁ and a corresponding first secondary winding n₂₁. Also, the second transformer T2 has a second primary winding n₁₂ and a corresponding second secondary winding n₂₂. More particularly, the first secondary winding n₂₁ is connected in parallel to the second secondary winding n₂₂, and the first primary winding n₁₁ is connected in parallel to the second primary winding n₁₂.

The square-wave generating circuit 202 is a half-bridge circuit which is composed of two semiconductor components, namely, a first semiconductor component Q1, a second semiconductor component Q2. Also, the square-wave generating circuit 202 is electrically connected to the voltage input terminal Vin. The first semiconductor component Q1 and the second semiconductor component Q2 are controlled by a controller 800 to be alternately in a turned-on state and a turned-off state to generate a pulsating voltage Vp at a node p.

The resonant circuit 204 is composed of a first capacitor C 1 and the primary windings n₁ of the transformers T1, T2. Also the resonant circuit 204 is electrically connected to the square-wave generating 202. More particularly, the first capacitor C1 is a resonant capacitor, which is provided to filter a DC component of the pulsating voltage Vp. Besides, an AC component of the pulsating voltage Vp is resonated with the primary windings n₁ of the transformers T1, T2 to generate a resonated voltage Vr at a node r. The resonated voltage Vr is coupled from the primary windings n₁ of the transformers T1, T2 to the secondary windings n₂ of the transformers T1, T2.

The rectifier circuit 208 includes at least two switch components, namely, a first switch component S1 and a second switch component S2. The rectifier circuit 208 is electrically connected to the secondary windings n₂ of the transformers T1, T2 to rectify the coupled resonated voltage Vr to generate a rectified voltage Vx at a node x. In this embodiment, a half-wave rectifier circuit is composed of the first switch component S1 and the second switch component S2.

The power supply apparatus further includes a filter circuit 210. The filter circuit 210 has a second capacitor C2, and the filter circuit 210 is electrically connected between the rectifier circuit 208 and the voltage output terminal Vout. More particularly, the second capacitor C2 is a filter capacitor to reduce a voltage ripple of the DC output voltage to smooth the variation of the DC output voltage based on the charging and discharging property of the second capacitor C2.

In this embodiment, the description of operating the power supply apparatus is as follows. The voltage at the node p is a positive voltage referenced to a ground when the first semiconductor component Q1 of the square-wave generating circuit 202 is turned-on and the second semiconductor component Q2 of the square-wave generating circuit 202 is turned-off. Hence, the voltages at the dot ends of the transformers T1, T2 of the conversion circuit 206 are positive. The first switch component S1 is turned-on and a first current I1 flows through the first switch component S1 to a voltage output terminal Vout.

In addition, the voltage at the node p is a negative voltage referenced to a ground when the first semiconductor component Q 1 of the square-wave generating circuit 202 is turned-off and the second semiconductor component Q2 of the square-wave generating circuit 202 is turned-on. Hence, the voltages at the dot ends of the transformers T1, T2 of the conversion circuit 206 are negative. The second switch component S2 is turned-on and a second current I2 flows through the second switch component S2 to a voltage output terminal Vout.

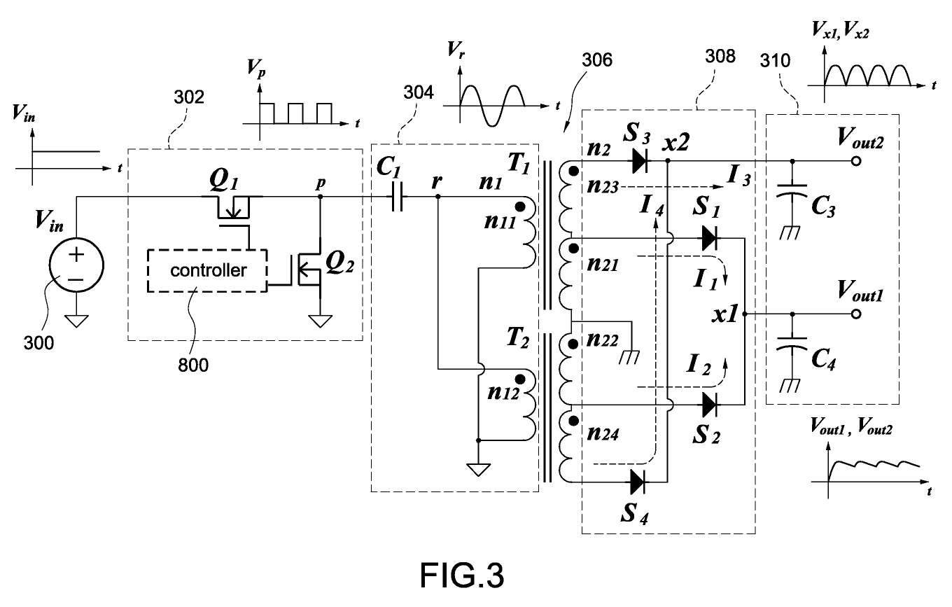

Reference is made to FIG. 3 which is a circuit diagram of a second embodiment of the power supply apparatus. The power supply apparatus includes a square-wave generating circuit 302, a resonant circuit 304, a conversion circuit 306, a rectifier circuit 208, and a filter circuit 310. The square-wave generating circuit 302 is a half-bridge circuit which is composed of two semiconductor components, namely, a first semiconductor component Q1, a second semiconductor component Q2. Also, the square-wave generating circuit 302 is electrically connected to a DC voltage 300 at the voltage input terminal Vin. The first semiconductor component Q1 and the second semiconductor component Q2 are controlled by a controller 800 to be alternately in a turned-on state and a turned-off state to generate a pulsating voltage Vp at a node p.

The resonant circuit 304 is composed of a first capacitor C1 and the primary windings n₁ of the transformers T1, T2. Also the resonant circuit 304 is electrically connected to the square-wave generating 302. More particularly, the first capacitor C1 is a resonant capacitor, which is provided to filter a DC component of the pulsating voltage Vp. Besides, an AC component of the pulsating voltage Vp is resonated with the primary windings n₁ of the transformers T1, T2 to generate a resonated voltage Vr at a node r. The resonated voltage Vr is coupled from the primary windings n₁ of the transformers T1, T2 to the secondary windings n₂ of the transformers T1, T2.

The conversion circuit 306 has four secondary windings n₂, namely, a first secondary winding n₂₁, a second secondary winding n₂₂, a third secondary winding n₂₃, and a fourth secondary winding n₂₄. More particularly, the four secondary windings n₂ are connected in series.

The rectifier circuit 308 includes four switch components, namely, a first switch component S1, a second switch component S2, a third switch component S3, and a fourth switch component S4. The rectifier circuit 308 is electrically connected to the secondary windings n₂ of the transformers T1, T2. More particularly, the first switch component S1 is electrically connected to the first secondary winding n₂₁, the second switch component S2 is electrically connected to the second secondary winding n₂₂, the third switch component S3 is electrically connected to the third secondary winding n₂₃, and the fourth switch component S4 is electrically connected to the fourth secondary winding n₂₄. The rectifier circuit 308 is provided to rectify the coupled resonated voltage Vr outputted from the secondary windings n₂ of the transformers T1, T1 to generate a rectified voltage Vx1 and a rectified voltage Vx2 at a node x1 and a node x2, respectively.

The filter circuit 310 has a third capacitor C3 and a fourth capacitor C4, and the filter circuit 310 is electrically connected to the rectifier circuit 308. One terminal of the third capacitor C3 is electrically connected to the third switch component S3, the fourth switch component S4, and a second voltage output terminal Vout2, respectively; and the other terminal of the third capacitor C3 is electrically connected to the ground. One terminal of the fourth capacitor C4 is electrically connected to the first switch component S1, the second switch component S2, and a first voltage output terminal Vout1, respectively; and the other terminal of the fourth capacitor C4 is electrically connected to the ground. More particularly, the third capacitor C3 and the fourth capacitor C4 are filter capacitors to reduce a voltage ripple of the DC output voltage to smooth the variation of the DC output voltage based on the charging and discharging property of the third capacitor C3 and the fourth capacitor C4.

In this embodiment, the description of operating the power supply apparatus is as follows. The voltage at the node p is a positive voltage referenced to a ground when the first semiconductor component Q1 of the square-wave generating circuit 302 is turned-on and the second semiconductor component Q2 of the square-wave generating circuit 302 is turned-off. Hence, the voltages at the dot ends of the transformers T1, T2 of the conversion circuit 306 are positive. Also, the first switch component S1 and the third switch component S3 of the rectifier circuit 308 are turned-on, hence, a first current T1 and a third current I3 flow toward the first voltage output terminal Vout1 and the second voltage output terminal Vout2, respectively.

In addition, the voltage at the node p is a negative voltage referenced to a ground when the first semiconductor component Q 1 of the square-wave generating circuit 302 is turned-off and the second semiconductor component Q2 of the square-wave generating circuit 302 is turned-on. Hence, the voltages at the dot ends of the transformers T1, T2 of the conversion circuit 306 are negative. Also, the first second component S2 and the fourth switch component S4 of the rectifier circuit 308 are turned-on, hence, a second current I2 and a fourth current I4 flow toward the first voltage output terminal Vout1 and the second voltage output terminal Vout2, respectively.

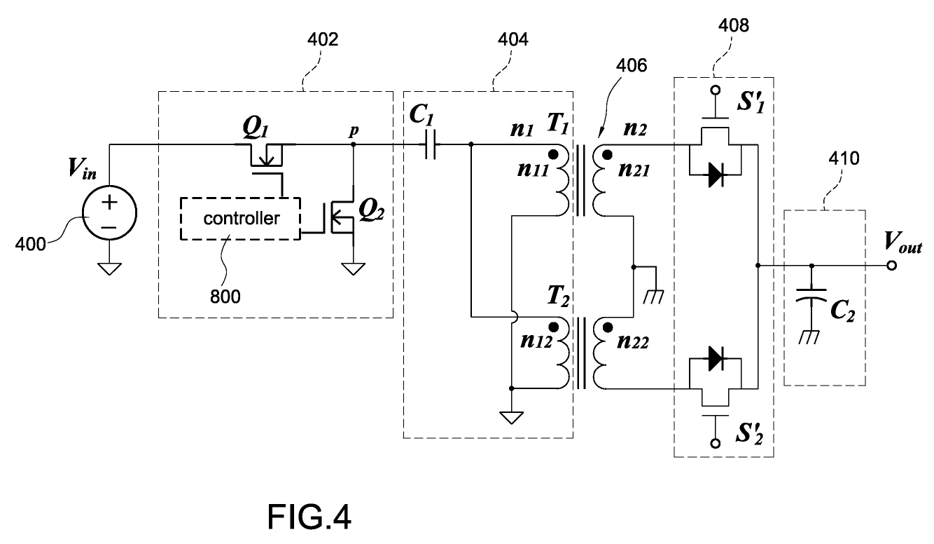

Reference is made to FIG. 4 which is a circuit diagram of a third embodiment of the power supply apparatus. The power supply apparatus includes a square-wave generating circuit 402, a resonant circuit 404, a conversion circuit 406, a rectifier circuit 408, and a filter circuit 410. More particularly, the connection relationship among the square-wave generating circuit 402, the resonant circuit 404, the conversion circuit 406, and the filter circuit 410 is the same as that shown in FIG. 2. However, the components of the rectifier-filter circuit 408 are only different. In this embodiment, both a first switch component S1′ and a second switch component S2′ can be MOSFETs to replace the rectifier diode to compose a synchronous rectifier.

The filter circuit 408 further has one diode electrically connected between a drain and a source of each MOSFET. The two diodes are used to avoid generating a high breakdown voltage, which tends to damage the two MOSFETs S1′, S2′, and further to increase switching speed of the two MOSFETs S1′, S2′. In addition, a switch driving circuit (not shown) is electrically connected to a gate of each MOSFET to drive and control the MOSFETs S1′, S2′.

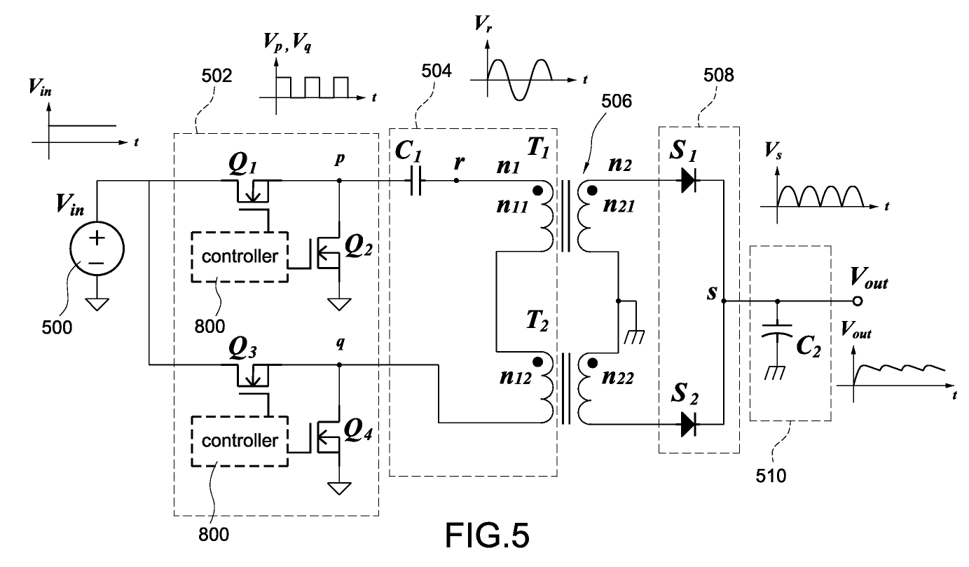

Reference is made to FIG. 5 which is a circuit diagram of a fourth embodiment of the power supply apparatus. In this embodiment, the above-mentioned half-bridge circuit of the square-wave generating circuit 202 can be replaced by a full-bridge circuit of a square-wave generating circuit 502. The full-bridge square-wave generating circuit 502 is composed of four semiconductor components, namely, a first semiconductor component Q1, a second semiconductor component Q2, a third semiconductor component Q3, and a fourth semiconductor component Q4, respectively. More particularly, the first semiconductor component Q1 and the second semiconductor component Q2 are electrically connected together and further electrically connected to a controller 800. Also, the third semiconductor component Q3 and the fourth semiconductor component Q4 are electrically connected together and further electrically connected to the controller 800. A first primary winding n₁₁ and a second primary winding n₁₂ of a resonant circuit 504 are electrically connected in series.

In this embodiment, the description of operating the power supply apparatus is as follows. First, a pulsating voltage Vp and a pulsating voltage Vq are generated at a node p and a node q, respectively, when a DC voltage 500 inputs to the square-wave generating circuit 502. Afterward, a first capacitor C 1 of the resonant circuit 504 is resonated with the primary winding n₁ of the conversion circuit 506 to produce a resonated voltage Vr. The resonated voltage Vr is coupled from the primary winding n₁ to the secondary winding n₂. The resonated voltage Vr is rectified by a filter circuit 508, and is filtered by a filter circuit 510 to reduce a voltage ripple of the DC output voltage to smooth the variation of the DC output voltage based on the charging and discharging property of the second capacitor C2.

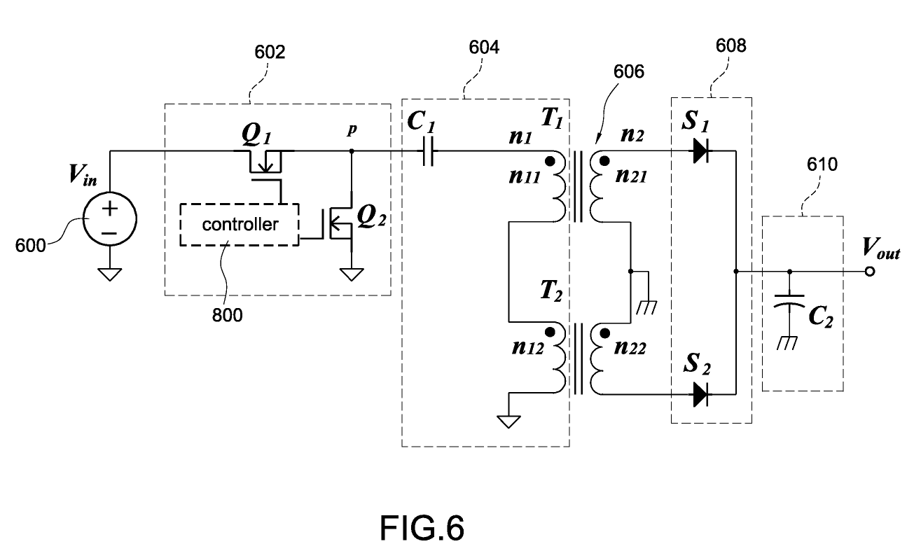

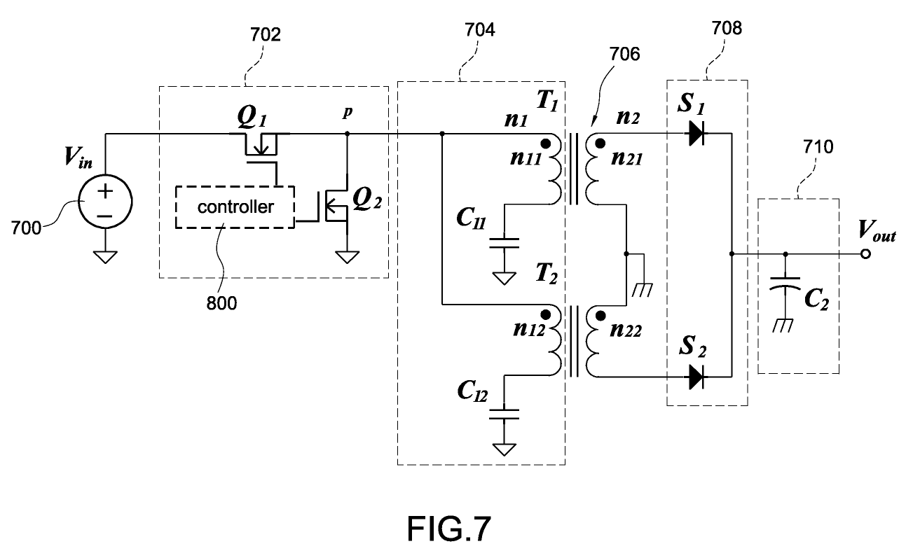

The main feature of the power supply apparatus is variation of connecting manner for the secondary windings, so the primary windings of the transformers can be electrically connected to varied resonant circuits, such as shown in FIG. 6 and FIG. 7. Reference is made to FIG. 6 which is a circuit diagram of a fifth embodiment of the power supply apparatus. The primary windings n₁ are of the transformers T1, T2 of the resonant circuit 604 electrically connected in series. The operation voltages of the primary windings n₁ are generated by dividing the voltage outputted from the square-wave generating circuit 602. Reference is made to FIG. 7 which is a circuit diagram of a sixth embodiment of the power supply apparatus. Two resonant capacitors C11, C12 of the resonant circuit 704 are electrically connected in series to the first primary winding n₁₁ and the secondary primary winding n₁₂, respectively, to filter the DC component and pass the AC component.

Accordingly, the secondary windings of two transformers are electrically connected in series to balance the magnetic flux of the two transformers to provide a current-sharing function. In addition, the amount of the diodes and the turns of the secondary windings is less to reduce the losses and increase the efficiency.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A current-sharing power supply apparatus, comprising:
a conversion circuit having two transformers, and each of the transformers having a primary winding and at least one secondary winding; wherein the secondary windings of the two transformers are electrically connected in series;
a square-wave generating circuit electrically connected to a DC voltage, and the square-wave generating circuit operable for switching the DC voltage into a pulsating voltage;
a resonant circuit electrically connected to the square-wave generating circuit, and the resonant circuit having a first capacitor and the primary windings of the transformers; and
a rectifier circuit having at least two switch components and electrically connected to the secondary windings of the transformers to rectify an AC output voltage outputted from the secondary windings into a rectified voltage, and to output the rectified voltage to at least one voltage output terminal.

2. The current-sharing power supply apparatus in claim 1, further comprising a filter circuit electrically connected to the rectifier circuit, and the filter circuit having at least one second capacitor; wherein the second capacitor is a filter capacitor to reduce a voltage ripple of the DC output voltage.

3. The current-sharing power supply apparatus in claim 1, wherein the switch components of the rectifier circuit are rectifier diodes.

4. The current-sharing power supply apparatus in claim 1, wherein the rectifier circuit is a synchronous rectifier circuit and the switch components are MOSFETs.

5. The current-sharing power supply apparatus in claim 4, wherein the rectifier circuit further comprises one diode electrically connected between a drain and a source of each MOSFET.

6. The current-sharing power supply apparatus in claim 1, wherein the two primary windings of the transformers of the conversion circuit are electrically connected in parallel.

7. The current-sharing power supply apparatus in claim 1, wherein the two primary windings of the transformers of the conversion circuit are electrically connected in series.

8. The current-sharing power supply apparatus in claim 1, wherein the square-wave generating circuit is a half-bridge circuit which is composed of two semiconductor components.

9. The current-sharing power supply apparatus in claim 1, wherein the square-wave generating circuit is a full-bridge circuit which is composed of four semiconductor components.

10. The current-sharing power supply apparatus in claim 1, wherein the first capacitor is a resonant capacitor.
